(19) United States
(12) Patent Application Publication
(10) Pub. No.: US 2022/0400602 A1
(43) Pub. Date: Dec. 22, 2022

(54) SOIL CULTIVATION ARRANGEMENT

(71) Applicant: Marian Ivanov Dichevski, Varna (BG)

(72) Inventor: Marian Ivanov Dichevski, Varna (BG)

(21) Appl. No.: 17/625,221

(22) PCT Filed: Jul. 7, 2020
(86) PCT No.: PCT/EP2020/069117

§ 371 Date: Aug. 9, 2022

(30) Foreign Application Priority Data
Jul. 8, 2019 (EP) PCT/EP2019/068252

(51) Int. Cl. A01C 5/06

(52) U.S. Cl. CPC A01C 5/062

(57) ABSTRACT

The invention relates to a soil cultivation arrangement (100), in particular a soil preparation arrangement, for the agricultural cultivation of a soil (500), in particular a field and/or arable land, with a carrier device for attaching to an agricultural tractor and with one or more soil cultivation units (200, 201, 202, 203) for preparing and/or generating a seed furrow (530), which soil cultivation units (200, 201, 202, 203) as modular components of the soil cultivation arrangement (100) can be connected to the carrier device as required and can be arranged along the carrier device in the desired sequence. At least one soil cultivation unit (200) has a runner-like sliding device (400), the underside of which, as sliding surface (410) facing the soil (500), is designed to slide on a soil surface (510).

The invention relates to a soil cultivation arrangement, in particular a soil preparation arrangement, for agricultural cultivation of a soil, in particular a field and/or arable land, with a carrier device for attachment to an agricultural tractor, in particular a tractor or a tug, and with one or more soil cultivation units for preparation and/or for generating a seed furrow. The soil cultivation units as modular components of the soil cultivation arrangement can be connected to the carrier device and/or to a sowing unit towable by an agricultural tractor and can be arranged along the carrier device in the desired sequence.

In industrial agriculture, soil cultivation is one of the most costly and time-consuming work processes in field or arable farming. In addition to intensive, turning soil cultivation, plowing, in which the soil of a field and/or arable area is turned and loosened in the uppermost, approx. 40 cm thick soil layer, gentler soil cultivation methods have now also become established on a large industrial scale. In the so-called no-plowing or non-plowing (also known as “no-till”) tillage methods, only superficial soil cultivation takes place. After the harvest, straw and crop residues can remain on the surface of the soil until the next sowing, thus protecting the soil from water and wind erosion and evaporation of soil moisture. For such conservation soil cultivation methods, however, fundamentally different demands are made on the technology. Despite the protective and conserving properties, straw, plant and root remains on the field or arable land or in the soil can prevent precise seed placement or represent a mechanical resistance for the seed, resulting in insufficient seed-to-soil contact.

Particularly in connection with the so-called single seed or single grain placement, in which the seed is placed single grain by grain along a prepared seed furrow after previous separation (e.g. by means of mechanical or pneumatic grain separation), insufficient seed-soil contact can lead to a considerable reduction in the harvest yield. Special soil cultivation devices for the non-plowing soil cultivation in connection with the single sowing or single grain depositing are designed to open or loosen the soil as well as to chop up straw and harvest residues, in particular to cut them and mix them effectively into the uppermost soil horizon. Such soil cultivation devices are usually built up from a series of different, mostly disk-shaped, tool elements with different functions.

Various combinations of such tool elements are known from the prior art. For example, EP 0 849 426 B1 discloses a sowing unit with an arm which is attached at a front-end region to a tool carrier of a tractor and is designed to accommodate various tool elements. The so-called furrow opener forms the essential part of the sowing unit. It represents an inclined and spring-mounted single disc that is pulled by the tractor in the forward direction of travel to create a seed furrow. To determine the depth of penetration of the furrow opener and the resulting furrow depth, a depth wheel is arranged near the leading side of the furrow opener. The depth wheel also serves to compact and stabilize the furrow wall. The seed is then released into the opened furrow by means of a coulter. The furrow opener is preceded by a furrow clearer (also known as “raw cleaner”) to remove plant and crop residues on the ground from the area in front of the furrow opener. The furrow clearer essentially consists of two disks that are positioned at an angle to each other, the circumference of which is provided with a tooth profile. Arranged following the furrow opener, a closing wheel rolls on the surface of the soil, which loosens the soil in the area of the furrow wall to close the previously opened furrow and at the same time presses against the seed lying in the furrow.

The furrow clearer described in EP 0 849 426 B1 works essentially above ground, i.e. clears straw and harvest residues above the soil surface. By means of a mostly waved, individual soil cultivation disc (also referred to as “coulter” or “disc opener”) can be “cut” into the upper soil horizon in order to chop up grown root residues also underground, i.e. below the surface of the soil, and thus to facilitate the opening of the seed furrow. Such a coulter or pre-cutter, if necessary, can be used in addition to or instead of the furrow clearer and is expediently arranged in front of the furrow opener. U.S. Pat. No. 7,992,651 B2 discloses a coulter with a wave-like disk surface. Before opening the actual seed furrow, the coulter should cut or slit the soil to a desired depth in order to loosen up the soil in this area and to separate any remains of plants or roots. In operation, the coulter, designed as a rotating disc, rolls along the surface of the soil or partially within the soil, the speed of rotation depending on the speed of movement of the towing vehicle. The required penetration depth of the coulters, previously determined by an agronomist, is determined based on the weight of the machine and the hardness of the soil. Due to the wavy disc surface, the effectively cut or slotted and loosened soil area is wider than the actual thickness of the disc. According to different embodiments, the coulter can be provided with a cutting edge formed on one or both sides along its circumference.

When removing biomass such as plant or root residues by means of such a coulters or pre-cutter, it is disadvantageous that the cutting of biomass is only generated during the rolling movement by the weight of the coulters, the total weight of the machine and/or by hydraulically or pneumatically generated pressure as well as by the tensile force exerted. Due to different soil hardness, which occur due to climatic conditions, in particular moisture or dryness, but also by the soil type, its compactness, brittleness and the penetration of the soil with biomass, there is also a high variability in the cutting quality. This often leads to incompletely severed biomass, which then collects within the seed furrow. When sowing, this means that the seed rests on the biomass, where it does not germinate and consequently does not produce any yield. This is one of the main causes of the well-known “hair-pinning” effect. This effect is, for example, described in the publication “Effects of Geometry of Disk Openers on Seed”; E. Seidi; International Journal of Agricultural and Biosystems Engineering Vol: 6, No: 12, 2012. With the “hair-pinning” effect, biomass that has not been completely severed and/or the seed furrow clogging collects between the seed grain and the soil, whereby the “seed-to-soil contact” decreases, the seeds germinate more slowly or not at all and ultimately the yield achieved by the harvest decreases.

A tool arm for a multi-row planting unit is known from US 2016/0050837 A1, which is pulled by a rural utility vehicle, a tractor or tug, in order to generate a plurality of seeds rows arranged parallel to one another and to stock them with seeds. The tool arm is equipped with various tool elements for preparing the soil, for creating the seed furrow, for spreading the seed and for closing the seed furrow. In one embodiment, so-called closing wheels are shown, each formed from two, in particular toothed wheels made of rubber, plastic or iron, on the outer circumference of which projections pointing obliquely outward on both sides enlarge the running surface of the closing wheels. As a result, the locking wheels act on the loosely piled soil next to the seed furrow and thus close the seed furrow.

Also from the S.I. Distributing Inc. is a similar locking wheel (https://sidist.com/index.cfm?fuseaction=category.display&category_ID=141&CFID=50302618&CFTOKEN=12808232&CFID=59384229&CFTO KEN=53824749, accessed on May 21, 2019) under the name “Finger-Till Closing Wheel” offered. The locking wheel is designed as a pair of disks with two disks that are positioned at an angle to one another and are each cast in one piece. Each disk comprises two rows of pyramidal projections on the outer circumference of the disk, one row pointing axially inward and the other row pointing radially outward. The axially inwardly pointing projections roll off in the area of the furrow walls in order to close the seed furrow, at the same time the radially outwardly pointing projections ensure loosening of the soil in this area.

However, the devices for conservative soil cultivation shown in the prior art also have disadvantages. This often leads to a compaction of the soil in the area of the seed furrow walls (also referred to as “side-wall-compaction”). Such a compaction of the soil can lead to a predetermined direction of growth of the roots of the sown plants within the seed furrow or along the seed furrow wall and consequently to a lower crop yield. Subsequent loosening of the soil in this area by means of appropriately designed closing wheels cannot adequately eliminate the compaction often caused by tool elements running in front, especially when the soil is wet. Furthermore, when removing, cutting, or separating biomass such as plant and root residues, by means of a coulters or pre-cutter, it is disadvantageous that the biomass is often cut incompletely. In addition, the depth of penetration of the coulters depends solely on the moisture content and the compaction of the soil as well as the weight of the coulters or the tool arm on which the coulters are suspended and can therefore hardly be varied or only with great effort.

It is therefore an object of the present invention to eliminate the disadvantages of the prior art and to create an improved soil cultivation arrangement. This arrangement, in particular, allows a more complete separation of biomass such as plant or root residues and the avoidance of furrow wall compaction and/or hair pinning effect together with an optimized seed-to-soil contact due to homogeneous soil density in the area of the seed furrow. At the same time, a homogeneous soil density promotes simultaneous germination of the seeds, which further increases the harvest yield.

The object is achieved by a soil cultivation arrangement according to claim 1 and a soil cultivation unit according to claim 13. Advantageous embodiments are claimed in the sub-claims and are explained more detailed below.

A soil cultivation arrangement according to the invention of the type described in more detail at the beginning is characterized in that at least one soil cultivation unit has a runner-like sliding device, the underside of which, facing the soil, is designed to slide on a soil surface.

For the flexible use of different soil cultivation units with different functions, the soil cultivation units can be connected to a carrier device of the soil cultivation arrangement and can be flexibly arranged along the sowing section in the case of seed drills or on another carrier device, if required, in the desired order. In addition or as an alternative, a connection with a sowing unit is also possible. Tool arms known from the prior art or other devices that enable the soil cultivation units to be suspended or fastened are suitable as the carrier device. The soil cultivation units are lined up along the carrier device in order to prepare the soil in the area of an individual seed furrow, to loosen it and finally to generate the seed furrow. Depending on the size of the field and/or arable land to be worked, several soil cultivation arrangements can be attached parallel to one another to a tool carrier of an industrial or agricultural tractor, in particular a tractor or tug, in order to prepare and/or generate a corresponding number of seed furrows. Advantageously, in the pulling direction of the agricultural tractor, initially a soil cultivation unit for cutting plant and/or root remains and for preparing the soil is arranged. A further soil cultivation unit for preparing the seed furrow and for loosening the soil in the area of the seed furrow to be generated can follow this. Finally, a soil cultivation unit can be provided for generating the seed furrow and at the same time for loosening the soil in the area of the seed furrow wall.

According to the invention it is provided, that at least one soil-working unit comprises a sliding device. The sliding device is provided with a sliding surface on the underside, which is parallel to the soil surface and is raised in the manner of a runner, a sledge or a ski in the pulling direction of the agricultural pulling tractor in order to enable the soil-working unit to slide on the soil surface. Together with the sliding device, both soil cultivation elements in the form of soil cultivation disks, but also soil cultivation elements that are not disc-shaped or do not roll along the ground, can be used, whereby a higher variability of the modular structure of the soil cultivation arrangement is achieved. The sliding device serves to reduce the friction between the soil cultivation unit and the soil surface and to determine and adjust the depth of penetration, in particular the distance between the device, biomass and soil. At the same time, biomass located on the soil surface, in particular plant or harvest residues, is held down and/or aligned flat to the soil surface, because of which the function of the soil cultivation elements is improved.

Due to the flexible equipment of the carrier device, depending on the nature of the soil to be worked and the condition of the field and/or arable land, e.g. the type and amount of remaining plants and crops or root remains or the moisture content, a desired combination of soil cultivation units can be modularly created put together. For example, the soil cultivation arrangement, if necessary, can be equipped with one or more of the soil cultivation units. Depending on the type and properties of the soil, it is also possible, for example, to assemble several soil cultivation units arranged in a row, in particular soil cultivation disks with a different penetration depth and/or a different diameter and subsequently also with a mutually different mass, if necessary. It has proven to be advantageous here to design the soil cultivation units arranged foremost with respect to the pulling direction of the agricultural tractor with the smallest penetration depth and/or the smallest diameter, with the penetration depth and/or diameter of further soil cultivation units increasing in opposite of the pulling direction. In the case of soil cultivation arrangements arranged parallel to one another for generating several parallel seed furrows, soil cultivation units which are arranged parallel to one another and have an identical penetration depth and/or an identical diameter are preferably formed in each case at the same position. By means of a suitable, modular arrangement of different soil cultivation units, compaction of the seed furrow, especially in the area of the seed furrow wall, can be prevented immediately before and/or during the seed furrow generation or the soil loosening in the area of the seed furrow wall.

The arrangement according to the invention can be supplemented additionally by further tool elements known from the prior art, such as, for example, a device for depositing the seeds, a furrow clearer or one or more closing wheels, or can be used together with them.

The soil cultivation arrangement according to the invention is particularly well suited for generating seed furrows for individual seeds, but can also be used advantageously for generating seed furrows with different dimensions, in particular for generating seed furrows for smaller seeds such as wheat, rape, barley, etc.

According to an advantageous embodiment of the invention, one or more soil cultivation elements therefore protrude, in particular penetrate, the sliding surface of the sliding device by a variably adjustable penetration or working depth.

The sliding device is preferably provided with a sliding surface on the underside, which is oriented parallel to the soil surface and which protrudes over, in particular is penetrated, by the one or more soil cultivation elements. For this purpose, the sliding device can be designed with corresponding recesses. Alternatively, it is also possible to arrange one or two sliding devices (each) adjacent to the soil cultivation element. The distance between the underside sliding surface of the sliding device and the area of the soil cultivation element that penetrates the soil, corresponds to the penetration or working depth within which the biomass, in particular plant and root residues, is cut and the soil is loosened, and/or corresponds to the depth of the seed furrow to be generated. Like the depth setting wheels of the sowing discs or “chicken feet” known from the prior art, the sliding device can thus be used for depth control; the penetration or working depth is variably adjustable.

In the prior art, however, the soil cultivation elements are designed as disks penetrating into the soil and rolling there, the rotational speed and direction of which consequently depends on or corresponds to the travel speed and pulling direction or forward travel direction of the agricultural tractor. At the same time, in the prior art, the support of the soil cultivation arrangement on the ground is realized via the disks that roll with them, as is the case with wheels. According to the invention, the latter is taken over by the sliding device, whereby, according to a variant of the invention, it is possible that the one or more soil cultivation elements are actuated independently of the travel speed and pulling direction or forward travel direction of the agricultural tractor.

The drive of such an active soil cultivation element or coulters, for example, can take place electrically, hydraulically, pneumatically or with other types of auxiliary gears, but always independently of the driving speed and direction of movement of the tractor. For example, it is possible, in order to increase the working accuracy, to implement the stability and guidance of the sliding device or also of an active soil cultivation element or coulters by means of the so-called parallelogram sowing section. Mounting the sliding device on the parallelogram sowing section also enables the movements of the active soil cultivation elements or the active roller, generated by the drive, to be synchronized with the sowing discs.

In this way, the direction of movement, in the case of soil cultivation elements designed as discs, the direction of rotation, and the speed of movement can be variably adapted in advance or even during operation to the prevailing soil conditions (such as plant and root residues) in order to optimize soil preparation, in particular soil loosening and/or optimized cutting of biomass, in particular plant and root residues. Active cutting of the biomass ensures that plant and root residues do not get into the seed furrow to be prepared, collect there in front of subsequent soil cultivation elements or soil cultivation units and clog them and/or accumulate below the sowing discs and reduce the seed-soil contact of the spread seeds or lead to the “hair-pinning” effect.

An advantageous embodiment of the invention provides that at least one soil cultivation element is designed as a pre-cutter and/or soil loosening unit and interacts with the sliding device for cutting biomass, in particular plants and root remains.

In a particularly advantageous development, the variant of the invention described above is designed as a pre-cutter with a single rotatable mounted soil cultivation disc, in particular a knife disc. Here the soil cultivation disc for cutting plant and root remains and for preparing the seed furrow to be generated is provided along its outer circumferential or running surface with a radially extending cutting and/or tooth profile.

In this development, the sliding device sliding on the soil surface fulfills the additional purpose of holding down biomass located there, in particular plant or harvest residues, and/or aligning it flat to the soil surface, which facilitates shearing off by means of the soil cultivation disc designed as a cutting disc. At the same time, it prevents the rotating knife disc of pulling out any remains of plants or roots available in the soil, i.e. below the soil surface.

In principle, it is possible, for example, in cases when only a small penetration of the soil with biomass is given, that the rotatable mounted soil cultivation disc, regardless of the travel speed and pulling direction or forward travel direction of the agricultural tractor, is actuated, but driven in the forward travel direction.

According to a further development of the invention, it is alternatively but advantageously provided, that the rotatable mounted soil cultivation disc of the pre-cutter is actuated independently of the travel speed and against the pulling direction or forward travel direction of the agricultural tractor.

An actuator-driven rotary movement of the soil cultivation disc that is opposite to the forward direction of travel enables particularly effective cutting of biomass. The soil cultivation disc, which in particular penetrates the soil, captures biomass in particular plant and root residues, located therein with its cutting and/or saw tooth profile, while at the same time biomass located above the soil is held down by the sliding device. The soil cultivation disc does not necessarily penetrate completely into the soil without interruption; it is also possible that the soil cultivation disc, at least partially, moves above the soil. The actual cutting or shearing process, in particular chopping off, takes place on the lower edges of the sliding device facing the soil on which the biomass carried by the soil cultivation disc, in particular plant and root residues, are retained. The cutting and/or saw tooth profile of the soil cultivation disc and the lower edges of the sliding device work together in the manner of scissors to cut and/or shear the biomass. The sliding device preferably has a slot-like recess through which the soil cultivation disc passes, and the edges of the slot-like recess are then sheared off accordingly. Due to the upward rotary movement of the soil cultivation disc that carries the biomass with it, which is also referred to as the active coulter, the biomass is transported laterally out of the area in which the seed furrow is generated with subsequent soil cultivation elements, in particular furrow openers or sowing discs, so that it is then free of biomass.

Optionally, according to one embodiment of the invention, at least one soil cultivation element is designed as a movable soil loosening unit and/or pre-cutter with one or more knives. These are used for cutting biomass, in particular plant and root residues, for loosening the soil and for preparing the seed furrow to be produced, translationally, in particular transversely, to the pulling direction or the forward direction of travel of the agricultural tractor.

Both the soil cultivation elements designed in the manner of soil cultivation disks described so far and the soil cultivation element designed with one or more knives can be provided with their own drive unit or can be driven externally. The drive unit is preferably designed as an electrically, pneumatically, mechanically or hydraulically driven rotary or linear actuator to rotate a respective soil cultivation disc in or against the pulling direction, e.g. to move in an oscillating manner the one or more knives transversely to the pulling direction or forward travel direction of the agricultural tractor, in particular vertically to the soil or enclosing another angle with the soil. For this purpose, the carrier device of the soil cultivation arrangement can have a holder or attachment option for a corresponding linear actuator, or the linear actuator is correspondingly attached to a sowing unit.

Via an assigned control, the speed and direction of rotation of the actuator-driven rotary movement of the one or more soil cultivation disks can be set as required, independently of the travel speed and travel direction of the agricultural tractor. By using the sliding device together with the drive unit, e.g. the setting of the desired speed and the direction of rotation of the actuator-driven rotary movement or other movement can be made easier and more precise by reducing the rolling effect on the soil or eliminating it.

In order to cut, shear or chop off effectively plant and/or root remains in the soil, the one or more knives move at high speed. For this purpose, the one or more knives are connected to the linear actuator in a manner known from the prior art and are mounted to be linearly movable. The mounting is preferably designed with clearance along the pulling direction and/or along the direction of movement of the knives that is transverse, in particular at a preferably right angle with the soil, or the knives are spring-mounted to compensate the appearance of stones or other inhomogeneity in the soil.

The soil loosening unit designed with one or more knives interacts with the sliding device in the manner described above, wherein, according to an advantageous development, the one or more knives of the soil loosening unit are arranged penetrating an, in particular slot-like, recess of the sliding device and preferably each knife has a respective, in particular slot-like, recess assigned within the sliding device. The biomass carried along in the upward movement of the one or more knives is retained by the sliding device and is cut and/or sheared off and/or chopped off at its edges or the edges of the slot-like recess.

The sliding device is intended to hold down plant residues, to improve and ensure the shearing performance and/or cutting performance and to prevent or minimize that root or plant residues are pulled out of the ground during the upward movement of the one or more knives.

Additionally or alternatively, according to a further variant of the invention, at least one soil cultivation unit can be designed as a soil-loosening unit with a revolving chain. This chain is actuated by an actuator to cut plant and root residues, to loosen the soil and to prepare the seed furrow to be generated in the manner of a chainsaw formed with a saw tooth profile.

According to one embodiment of the invention, at least one soil cultivation element is designed as a soil-loosening unit with a soil-loosening wing that engages in the soil starting from the sliding surface of the sliding device.

Preferably, the soil-loosening wing is a blade-like metal sheet, which has a particularly fin-like shape, e.g. comparable to the first dorsal fin of a shark.

In a further development of this embodiment of the invention, the soil-loosening wing is arranged to pass, in particular penetrate, the sliding device and can be locked in different positions on the sliding device for the variable setting of a desired working or penetration depth.

With this configuration, the penetration depth of the soil-loosening wing can be adapted to the prevailing conditions in a simple and uncomplicated manner, if necessary. The farmer according to his knowledge and skills based on the nature of the soil, the prevailing climatic conditions, and the seeds to be sown, etc. specifies the desired depth of penetration. The depth of penetration to be selected preferably depends on the depth of the soil up to which this has a moisture content necessary for the germination of the seeds.

In order to achieve particularly good soil loosening, also in the area of the seed furrow walls, the side surfaces of the soil loosening wing facing the respective seed furrow wall are provided with loosening pins and/or, in particular shovel or wing-like, loosening elements. The loosening pins and/or loosening elements for loosening of the soil are arranged in the region of the respective seed furrow wall.

In operation, i.e. when the soil cultivation arrangement with its soil cultivation units arranged one behind the other is pulled by an agricultural tractor over the soil area, the part of the soil loosening wing arranged below the sliding device protrudes into the soil at the desired working or penetration depth, with the loosening pins and/or loosening elements arranged, in particular on both sides, moved horizontally along the seed furrow walls. Thus, a soil traversed by fine cracks or finely scratched can be produced precisely in the area of the seed furrow walls, whereby the known problem of soil compaction, in particular the side wall compaction of the seed furrow, is countered. It is precisely in interaction with subsequent sowing discs and/or further soil cultivation units for loosening the soil that an optimal loosening and/or homogeneous mixing of the soil can be generated for preparing the seed furrow walls. The particularly conical or cylindrical loosening pins and/or, for example, in the form of wings, spikes, shovels or rails, can be aligned parallel or at an angle to one another and optionally arranged on one or both sides of the soil loosening wing. Optionally, the soil loosening wing can have a pipe or a hose running perpendicular to the sliding device, which can be used to supply the soil with liquid nutrients and/or liquid fertilizers. For this purpose, the working or penetration depth of the loosening wing should be below the seed placement depth.

In order to provide the soil loosening wings or, if necessary, other soil cultivation elements with the loosening pins and/or loosening elements, a manufacturing method has the following steps:
Provision of a soil cultivation element with two lateral, respectively adjacent seed furrow walls associated side surfaces,
Providing a desired number of, in particular cylindrical or conical, loosening pins and/or loosening elements
Generating receiving recesses by erosion and/or drilling methods on one or both side surfaces of the soil cultivation element, the circumferential shape of the generated receiving recesses corresponding to the circumferential shape of the loosening pins and/or loosening elements provided, and then
Joining the soil cultivation disc with the loosening pins and/or loosening elements, wherein the loosening pins and/or loosening elements are fitted, in particular pressed, into the receiving recesses by form, power or frictional fit.

According to the method, the soil cultivation element and the loosening pins and/or loosening elements are each provided as individual, separate components. The soil cultivation element can, for example, be a cast steel or iron part with a very high Rockwell hardness in a range of over 60 HR. Due to the high hardness, the service life of the soil cultivation element can be increased due to less wear. The loosening pins and/or loosening elements provided can be made from a similar technical material with approximately the same or less hardness and are in particular cylindrical or conical. The hard metal tungsten carbide has proven to be a particularly advantageous technical material. In order to join the provided loosening pins and/or loosening elements to the soil cultivation element, the soil cultivation element is first provided with receiving recesses, in particular in the form of a blind hole, on one or both side surfaces. Due to the high hardness of the material of the soil cultivation element, the receiving recesses are preferably formed by means of a so-called electro-erosion drilling process (EDM process). Alternatively, the receiving recesses can also be designed in the form of openings, which completely penetrate the soil cultivation element.

The receiving recesses and the loosening pins and/or loosening elements are designed with the same circumferential shape and preferably with an identical cross section, so that the loosening pins and/or loosening elements can be pressed and/or hammered into the receiving recesses. If the receiving recesses are continuous, i.e. are designed to completely penetrate the soil cultivation element, the loosening pins and/or loosening elements can additionally be welded to the soil cultivation element by setting an argon welding point or, depending on the material, soldered if necessary.

Alternatively, the loosening pins and/or loosening elements can be joined by means of a so-called high-temperature soldering process using silver, bronze, brass or copper solder and a corresponding flux, which are particularly suitable for high-temperature soldering processes in connection with hard metals, in particular tungsten carbide. It is also possible to manufacture the loosening pins and/or loosening elements by build-up welding (laser cladding) or 3D laser printing.

The previously described soil cultivation units can each be connected to a soil cultivation arrangement according to the invention in a modular manner and in the desired sequence. As is known from the prior art, the soil cultivation units are each spring-loaded or connected to the carrier device of the soil cultivation arrangement via corresponding arms and are movably mounted in order to be able to compensate stones or other unevenness in the soil, for example. In addition to the dead weight, continuous contact of the respective running or sliding surfaces with the soil can also be ensured in a manner known from the prior art by setting a pre-tension. All soil cultivation units or their soil cultivation elements, in particular pre-cutters, active coulter and/or soil loosening units, can be used for the types of soil cultivation arrangements known from the prior art with and without anchors, shafts or tines, which are used in particular to carry out a non-plowing (no-till), minimal plowing (minimum-till), row-wise plowing (strip-till) or vertical (vertical-till) tillage etc., in which the upper or deeper soil layers are loosened and opened. The suspension of the soil cultivation elements, in particular the active coulters, is adapted to seeders for field sowing or row sowing (planting) as well as to other types of soil cultivation arrangements. Other types of soil cultivation arrangements are, for example, soil cultivation machines for strip-like, vertical plowing (strip-till, vertical-till). According to one embodiment of the invention, in the case of an active pre-cutter, in particular an active coulter, the cutting takes place in the upward direction or away from the ground, in the direction of the sky, so that hardly any pressure is required. In this case, clean, biomass-free soil cultivation is made possible by the non-driven, stationary soil cultivation elements subsequently attached to the carrier device, in particular soil loosening units or through the soil loosening wing. Alternatively, they can also be attached to the carrier device in a vibrating manner, indirectly by a suspension mechanism, leaf-sprung, spring-loaded, by airbag, nitrogen damper or another type of suspension known from the prior art.

The soil loosening elements known from the prior art are mostly referred to as looseners or “shanks”, regardless of whether they are placed on no-till or on tillage machines (strip-like, vertical, minimal plowing), and only result in extremely coarse loosening of the soil. Experience has shown that the conventional coulter does not always succeed in cutting through the biomass for the subsequent shanks, so that it clogs. Particularly in dry soil conditions, a conventional coulter does not penetrate the soil sufficiently; the biomass remains impervious and begins to clog the flowingly arranged elements. The same applies to spring tines machines, which are only equipped with spring tines, which have no cutting coulter or which does not cut through the biomass, whereby the tines (spring tines) are clogged.

The respective soil cultivation units are also suitable for retrofitting soil cultivation arrangements and/or sowing units known from the prior art.

The object set out at the beginning is therefore also achieved by a soil cultivation unit for connection to a carrier device of a soil cultivation arrangement according to one of the preceding claims, with one or more soil cultivation elements for loosening the soil and/or for cutting biomass, in particular plant and/or root residues. The soil cultivation unit has a runner-like sliding device for limiting the working or penetration depth of the one or more soil cultivation elements, whereby the sliding surface of the sliding device is being designed to slide on a soil surface.

In an advantageous embodiment of the soil cultivation unit according to the invention, it has at least one soil cultivation element designed as a pre-cutter and one soil cultivation element designed as a soil-loosening unit. Each, the soil cultivation element designed as a pre-cutter and as a soil loosening unit, protrude, in particular penetrating, the sliding surface of a common sliding device by a variably adjustable working or penetration depth.

In this configuration, the pre-cutter, in particular an active coulter preferably runs ahead of the soil-loosening unit. This is particularly advantageous in order to free completely the seed furrow to be produced from biomass, in particular plant or root residues, by means of the pre-cutter, or to comminute the biomass in such a way that blockages by biomass on the following element, the soil-loosening unit, are avoided.

The configuration or arrangement of the soil cultivation elements described can be used for both row crop and seed drills. In both cases, one or two seeding disks can follow the arrangement of pre-cutter and soil-loosening unit, if necessary, whose respective side surfaces facing a seed furrow wall can be provided with the loosening pins and/or loosening elements described above. The pre-cutter running foremost, for example designed as a rotating knife disc, if necessary, can be provided with loosening pins and/or loosening elements. During operation of the soil cultivation arrangement, the loosening pins and/or loosening elements attached to the rotating soil loosening unit or sowing disc move along epicycloid paths through the soil of the respectively adjacent seed furrow walls. In combination with loosening pins and/or loosening elements arranged on a non-rotating soil loosening unit, in particular a soil loosening wing, which run through the soil of the adjacent seed furrow walls along horizontal paths, this results in a soil that is completely loosened in the area of the seed furrow walls and which is interspersed with fine furrows that intersect each other through different angles. The problem of furrow wall compaction and the associated loss of harvest can thus be completely countered. The pre-cutter, in particular a rotating knife disc, and the soil loosening unit, in particular a soil loosening wing, can optionally be arranged on a common sliding device or connected to a respective sliding device. It is essential that the soil-loosening unit be positioned between the leading pre-cutter and the trailing sowing discs. Expediently, all of the soil cultivation elements of the soil cultivation unit are connected to the sowing section in order to enable uniform pressure and a synchronized penetration of the soil.

An actively driven pre-cutter, in particular an active coulter, together with a sliding device, is also referred to below as a residue-safe cutting system (residue-sure-cut system). In most of the configurations of soil cultivation arrangements described above, this cutting system should be mandatory in order to ensure a surface that is clean of biomass and the trouble-free operation of subsequent elements. The first element of the residue-proof cutting system can be a furrow clearer to make the active coulter's work easier and to reduce the biomass in front of him, in front of the seed drill or another soil cultivation system.

Another particularly advantageous component of the residue-proof cutting system (Residue-Sure-Cut-System) is the possibility of using it not only for soil preparation with seed drills, but also in an absolutely individual, independent manner in other soil cultivation machines for minimal, striped and vertical-plowing and normal plowing, which have differently oriented and penetrating working bodies. These working elements usually do not rotate; they are not discs, but looseners or spring tines. They can be spring-loaded with a nitrogen shock absorber, an air cushion or otherwise attached directly to the frame of the soil cultivation machine or to the towing frame. Under normal conditions, they would be constantly clogged and hindered by the uncut biomass in front of them.

It is particularly important to mention that the residue-proof cutting system (Residue-Sure-Cut-System) does not require a large inventory weight for the biomass to be cut. Even if the disc barely penetrates the soil, the biomass is cut perfectly.

Due to the previously mentioned functionality of the residue-free cutting system (Residue-Sure-Cut-System), the cut takes place between the sliding device and the cutting disc. This reduces the weight of the entire equipment, which in turn leads to a reduction in the compactness of the soil, which is a particularly big problem for the growing of all vegetable crops.

Further details, features, (sub)combinations of features, advantages and effects based on the invention emerge from the following description of preferred exemplary embodiments of the invention and the drawings. These show in

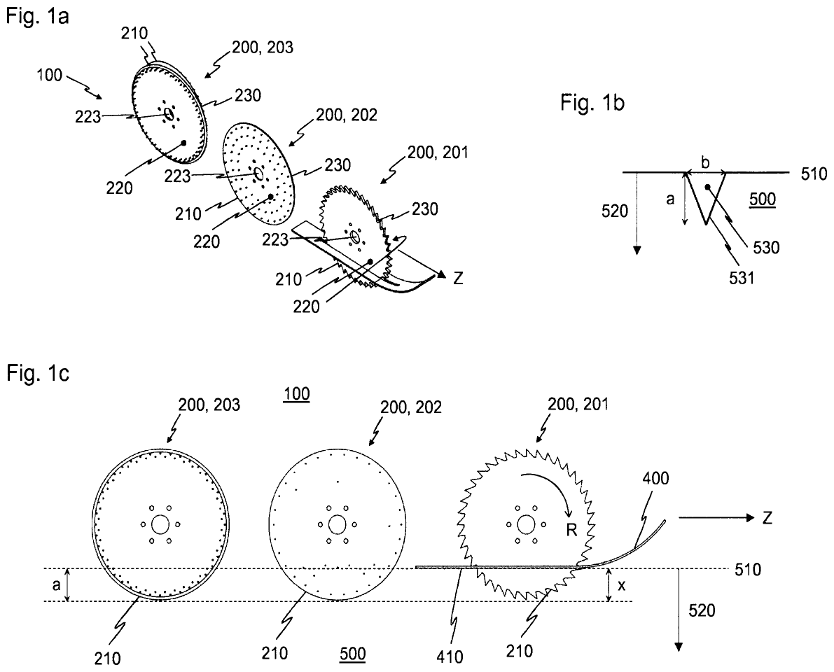

FIG. 1a a schematic perspective illustration of an exemplary embodiment of the soil cultivation arrangement according to the invention with three soil cultivation units arranged one after the other, each designed as a soil cultivation disc,

FIG. 1b a schematic sectional illustration of a seed furrow to be produced in a front view,

FIG. 1c the soil cultivation arrangement from FIG. 1a in a schematic side view,

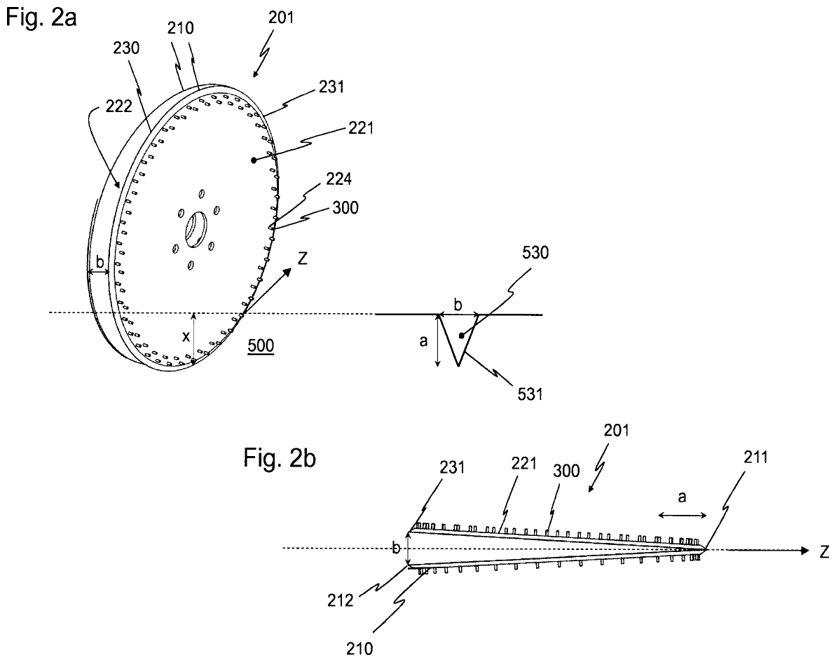

FIG. 2 a schematic perspective illustration of a first exemplary embodiment of a soil cultivation unit according to the invention, comprising a soil loosening unit with three knives, together with a schematic sectional illustration of a seed furrow to be produced,

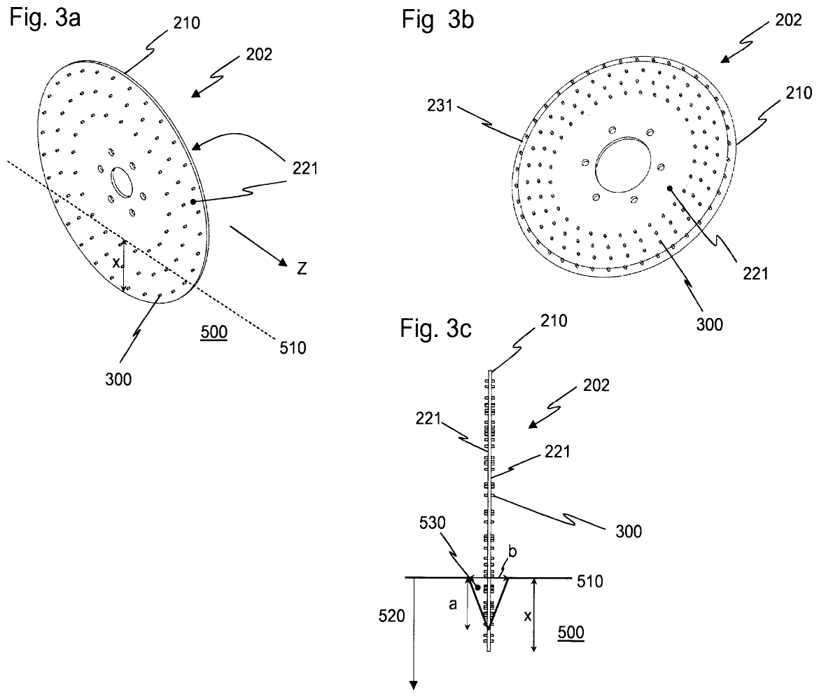

FIG. 3 a schematic perspective illustration of a further exemplary embodiment of a soil cultivation arrangement according to the invention with a revolving saw chain and together with a furrow opener or a sowing disc,

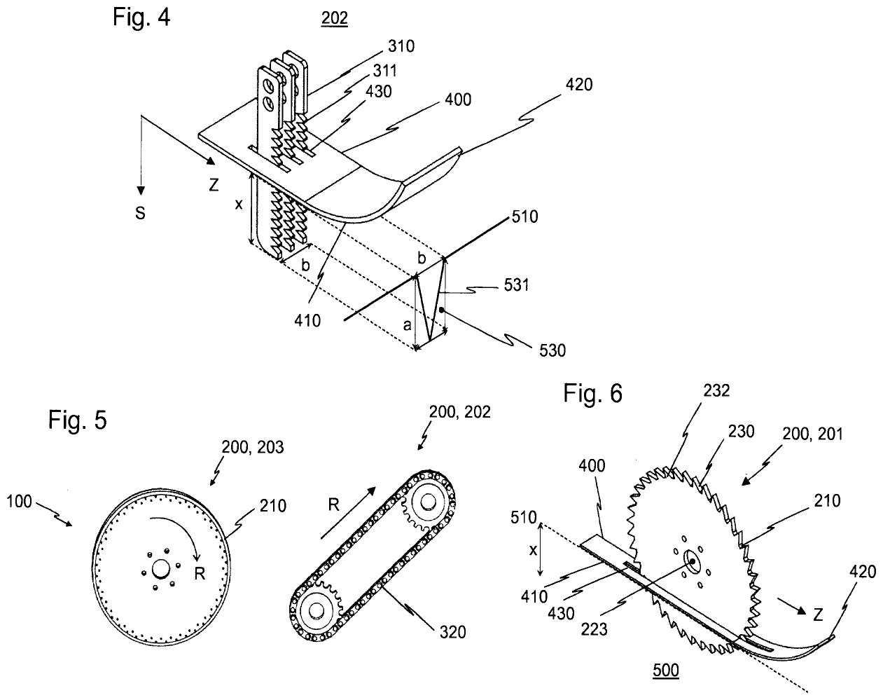

FIG. 4 a schematic perspective illustration of a second exemplary embodiment of a soil cultivation unit according to the invention with a pre-cutter with a rotatable mounted knife disc and a sliding device,

FIG. 5a a third exemplary embodiment of a soil cultivation unit according to the invention with a pre-cutter and a soil-loosening wing in a side view, according to

FIG. 5b in a perspective view and according to

FIG. 5c a detailed view of the soil-loosening wing,

FIG. 6a a fourth exemplary embodiment of a soil cultivation unit according to the invention with a pre-cutter and a soil-loosening wing in a side view and according to

FIG. 6b a detailed view of the soil-loosening wing,

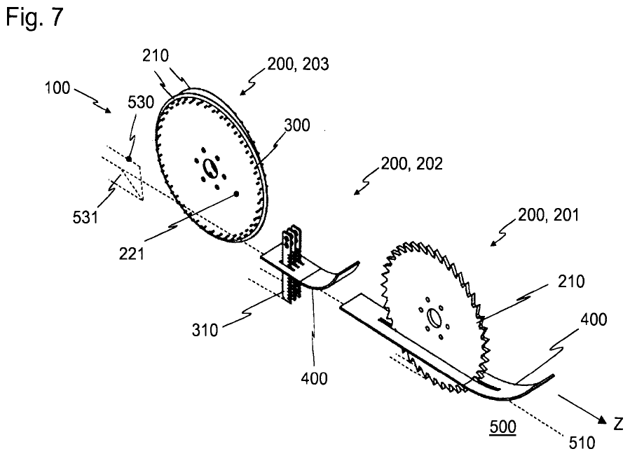

FIG. 7a a fifth exemplary embodiment of a soil cultivation unit according to the invention with a pre-cutter and a soil-loosening wing in a side view and according to

FIG. 7b a detailed view of the soil-loosening wing

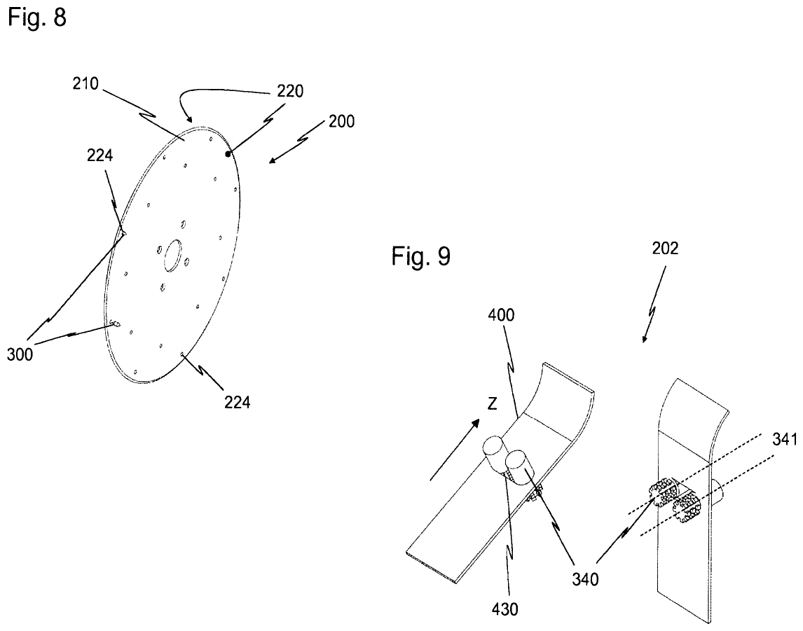

FIG. 8 a schematic side view of a further exemplary embodiment of the soil cultivation arrangement according to the invention with three soil cultivation units arranged one after the other,

FIG. 9 two schematic perspective views of an exemplary embodiment of a soil loosening unit according to the invention with two milling heads arranged next to one another and in parallel,

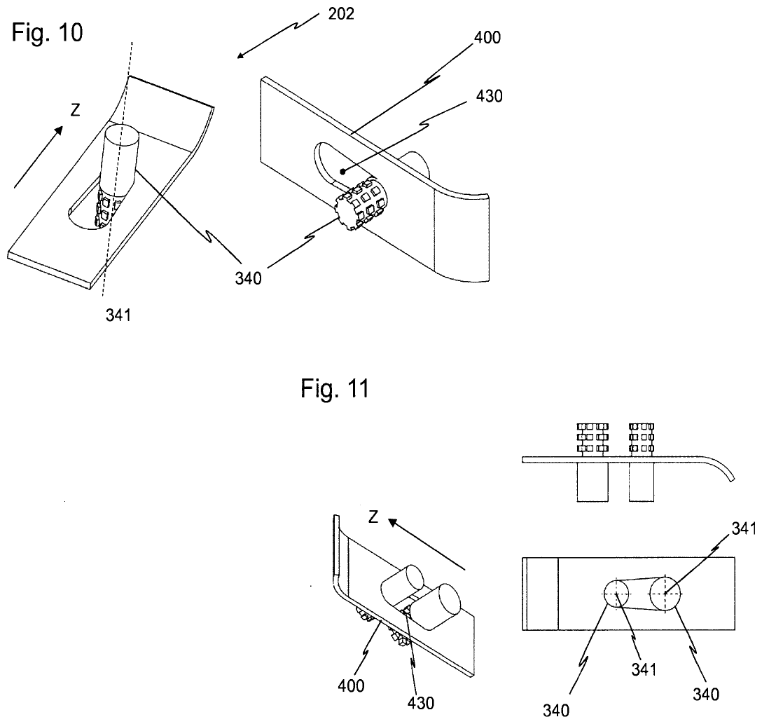

FIG. 10 two schematic perspective views of an exemplary embodiment of a soil loosening unit according to the invention with a single milling head and

FIG. 11 three schematic perspective views of an exemplary embodiment of a soil-loosening unit according to the invention with two milling heads arranged one behind the other or in a row.

The figures are merely exemplary in nature and are only used for understanding the invention. The same elements are provided with the same reference symbols, which is why they are usually only described once.

FIG. 1a shows a first exemplary embodiment of a soil cultivation arrangement 100 according to the invention. The soil cultivation arrangement 100 has three soil cultivation units 200, which are modularly connected to a not shown here carrier device of the soil cultivation arrangement 100 in a manner known from the prior art. The carrier device of the soil cultivation arrangement 100 is designed for connection to a tool carrier of an agricultural tractor, also not shown here, in particular a tractor or tug. The soil cultivation units 200 are in turn arranged one after the other along a pulling direction or forward travel direction Z of the agricultural tractor. The soil-cultivation unit 200 arranged foremost in the pulling direction Z has a soil cultivation element 210 in the form of a pre-cutter 201 and a sliding device 400. Likewise, with respect to the direction of pull Z, the pre-cutter 201 is followed by a soil cultivation unit 200 designed as a soil-loosening unit 202. The pre-cutter 201 and the soil-loosening unit 202 are each designed as a single soil cultivation disc. As the rearmost module of the soil cultivation arrangement 100, a soil cultivation unit 200 in the form of a furrow opener or sowing disc 203 follows the soil-loosening unit 202. The furrow opener or the sowing disc 203 comprises two soil cultivation discs arranged opposite one another. The soil cultivation disks of the soil cultivation units 200 each have two lateral circular surfaces 220 as well as a circumferential or running surface 230 and are mounted rotatable about their respective axis of rotation 223.

A schematic sectional illustration of a conventional, exemplary seed furrow 530, which can be prepared and produced with the soil cultivation arrangement 100, can be seen in FIG. 1b. The seed furrow 530 is formed with an approximately V-shaped cross-sectional area within the soil 500, more precisely in the uppermost soil horizon 520, and comprises two sloping seed furrow walls 531. The seed furrow depth a is the distance from the soil surface 510 to the deepest point of the seed furrow 530, also known as the furrow base. The seed furrow width b is usually measured in the area of the soil surface 510 and is defined as the distance between the two seed furrow walls 531 in this area. The seed furrow width b is usually in a range between 3.75 cm to 4 cm and the seed furrow depth a in a range between 3 cm to 10 cm. In order to prepare and generate the seed furrow 530, the soil cultivation arrangement 100 is pulled from the agricultural tractor along the pulling direction Z according to FIG. 1a, wherein the rotatable mounted soil cultivation disks usually roll along their respective circumferential or running surface 230 on the soil 500. The pre-cutter 201 and the soil-loosening unit 202 are each provided for preparing the seed furrow 530 and for loosening the soil in the uppermost soil horizon 520, along a cross-sectional area within which the seed furrow 530 is to be created. The actual seed furrow 530 is opened or pulled by means of the following furrow opener or sowing discs 203.

In FIG. 1c, the soil cultivation arrangement 100 from FIG. 1a is shown in a schematic side view. In this illustration, the soil 500 and its soil surface 510 are also indicated schematically. In conservation tillage, the soil 500 is cultivated exclusively within the uppermost soil horizon 520. The soil cultivation units 200, each having one or two soil cultivation discs, the soil loosening unit 202 and the furrow opener or the sowing disc 203, roll along the soil 500 or on its surface 510 and penetrate the soil 500, preferably in each case by the same working or penetration depth x, which also roughly corresponds to the seed furrow depth a. Alternatively, and not shown here, it can also be expedient that the pre-cutter 201 and/or the soil loosening unit 202 penetrate deeper into the soil 500, i.e. have a greater working or penetration depth x than the furrow opener 203, which also causes that soil in the area below the seed furrow 530 can be loosened. The working or penetration depth x or seed furrow depth a can be adjusted to the desired amount as required depending on the optimal planting depth of the seed.

For setting the working or penetration depth x, among other things, the pre-cutter 201, for example in the FIG. 1c, has a sliding device 400, the underside sliding surface 410 of which slides along the soil surface 510. By offsetting the soil cultivation disc and the sliding device 400 of the pre-cutter 201 relative to one another, the distance by which the soil cultivation disc protrudes, in particular penetrates, beyond the underside sliding surface 410 and thus its working or penetration depth x can be determined. The sliding device 400 consequently fulfills the function of the devices known from the prior art and is optionally also applicable to the invention for setting the working or penetration depth x, such as depth wheels or so-called “chicken feet” and is mounted in a similar manner on a carrier device, not shown here, of the soil cultivation arrangement 100. In addition, the sliding device 400 also supports the soil cultivation unit 200 on the soil 500, which enables the soil cultivation disc of the pre-cutter 201 to be actively driven in the illustrated direction of rotation R, counter to the direction of pull Z. For this purpose, the soil cultivation unit 200 can be provided with an electrical, hydraulic, pneumatic and/or other gear equipped drive or actuator known from the prior art.

A schematic perspective illustration of a first exemplary embodiment of a soil cultivation unit 200 according to the invention with a soil cultivation element 210 designed as a soil loosening unit 202 can be seen in FIG. 2, together with a schematic section of a seed furrow 530 to be generated. The embodiment of the soil loosening unit 202 shown here is designed with a total of three knives 310, which are provided with a saw profile 311 in the pulling direction Z and can be moved up and down linearly in translation along a cutting direction S running orthogonally to the pulling direction Z. The soil loosening unit 202 also has a sliding device 400, the sliding surface 410 of which is provided for sliding on the soil surface 510. A front section 420 of the sliding device 400 in the pulling direction Z is raised in the manner of a runner with respect to the ground surface 510 in order to facilitate sliding off even on uneven soil. Three slot-like recesses 430 of the sliding device 400, arranged parallel to one another, are each penetrated by one of the knives 310. At the same time, they function as a kind of guide in the cutting direction S. The sliding device 400 can be used to variably set the working or penetration depth x of the knives 310. In addition, the sliding device 400 prevents plant or root residues from being pulled out of the soil 500 by an upward movement of the knives 310 and holds them back under itself. The actual cutting process takes place on the lower edges of the slot-like recesses 430 facing the soil 500, where the knives 310 and the sliding device 400 are cooperating in the manner of scissors. The set working or penetration depth x preferably corresponds to the seed furrow depth a, and the distance between the two outer knives 310 corresponds to the seed furrow width b of the seed furrow 530 to be generated. As can be seen from the schematic sectional view of the seed furrow 530, the embodiment of the soil loosening unit 202 shown here loosens the soil 500 transversely to the direction of pull Z along a rectangular cross-sectional area. The V-shaped cross-sectional area of the seed furrow 530, in particular in the area of the seed furrow walls 531 protrudes, which effectively prevents soil compaction here. The knives 310 can be driven electrically, hydraulically, pneumatically or mechanically via a conventional linear actuator and are mounted, preferably spring-loaded and/or with clearance, so that they can move up and down along the cutting direction S.

FIG. 3 shows a schematic perspective illustration of a further exemplary embodiment of a soil cultivation arrangement 100 with two soil cultivation units 200. The soil cultivation arrangement 100 has the soil cultivation unit 200 designed as a furrow opener or as a seeding disc 203 and a preceding soil cultivation unit 200 with a soil cultivation element 210 designed as a soil cultivation unit 202, which is constructed with a revolving soil cultivation chain 320. The soil loosening chain 320 of the soil loosening unit 202 is preferably driven electrically, hydraulically, pneumatically or mechanically via an actuator and is attached to the carrier device of the soil cultivation arrangement 100. If necessary, it can circulate, “forwards” in the rolling direction of the soil cultivation discs of the furrow opener 203 or “backwards” in opposite to the direction of rotation R indicated schematically. The soil loosening chain 320 is preferably provided, at least in sections, with a saw tooth profile, not shown here, the teeth of which extend straight or obliquely, in particular radially, outward, in the direction of the soil 500.

The soil loosening unit 202 having the soil loosening chain 320 has a sliding device 400 according to FIGS. 1a, c, not shown here, for setting the working or penetration depth x. A pre-cutter, in particular an active coulter, to avoid clogging with plant and root residues, can precede the soil loosening chain.

A soil cultivation element 210 embodied as a pre-cutter 201 of a second exemplary soil cultivation unit 200 for a soil cultivation arrangement 100 can be taken from FIG. 4, for example, in a schematic perspective illustration. The pre-cutter 201 comprises a single soil cultivation element 210, which is mounted rotatable around its axis of rotation 223 and is aligned parallel to the pulling direction Z. Here it is projected as a circular saw-like knife disc for cutting plant and root residues, rotates in counter to the pulling direction Z, i.e. cuts with an variably adjustable speed of rotation, and prepares the seed furrow 530 to be produced. Along the circumferential or running surface 230, the soil cultivation element 210 is provided with a tooth profile 232 pointing radially outward. Through the actuator-driven rotation of the soil cultivation element 210, any plant or root residues present on the soil surface 510 or in the soil 500 are taken or carried along by the rotary movement and finally cut, in particular in cooperation with the sliding device. In order to make it easier to shear off plant or root remains, the pre-cutter 201 is therefore additionally designed with a sliding device 400, the front section 420 of which is raised in a runner-like manner with respect to the ground surface 510. The soil cultivation disc penetrates a centrally arranged and elongated slot-like recess 430 of the sliding device 400. During operation of the soil cultivation arrangement 100, the soil cultivation unit 200 is moved along the pulling direction Z, the sliding device 400 sliding with its underside sliding surface 410 along the soil surface 510 and holding down any plant residues or pressing between them and the soil 500 for guaranteed cutting. At the same time, the sliding device 400 prevents any root residues located in the soil 500 from being pulled out of the soil 500 by the rotating soil cultivation disc 210. In addition, the sliding device 400 is used to set the working or penetration depth x of the pre-cutter 201.

FIGS. 5a to 5c show a third exemplary embodiment of a soil cultivation unit 200 according to the invention with a soil cultivation element 210 designed as a pre-cutter 201 and a soil cultivation element 210 designed as a soil loosening unit 202. Both the pre-cutter 201 and the soil loosening unit 202 pass through a common sliding device 400 which slides with its sliding surface 410 on the underside along the soil 500 or on the soil surface 510. In operation, the sliding device 400 cooperates with the pre-cutter 201. In this case, biomass to be cut, in particular plant and root residues, is retained by the sliding surface 410 of the sliding device 400. The relative movement of the rotating pre-cutter 201 causes the cut to take place at the edges of the recess 430 of the sliding device 400. The pre-cutter 201 essentially corresponds to the previously described embodiments and is therefore not described again in detail. The soil cultivation element 210, which is designed as a soil loosening unit 202, follows the pre-cutter 201 and comprises a soil loosening wing 350 which, starting from the underside sliding surface 410 of the sliding device 400, extends towards the soil 500. The working or penetration depth x of the soil loosening wing 350 is determined by the sliding device 400. For this purpose, an upper section 351 adjoining the soil loosening wing 350 of the soil loosening unit 202 penetrates a correspondingly designed recess 430 and can be attached to the sliding device in specific, predetermined positions, for example by means of screws or similar fastening means. For this purpose, the upper section 351 has a number of bores or other recesses that are spaced apart from one another. As can be seen from the detailed view in FIG. 5c, the side surfaces 351 facing the respectively adjacent seed furrow walls 531 are provided with loosening pins and/or loosening elements 300, which extend in the direction of the seed furrow walls 531. The loosening pins and/or loosening elements 300 here are shown conical and move during operation, i.e. when the soil cultivation unit 200 is pulled along the pulling direction Z, along a horizontal path through the soil located in the region of the seed furrow walls 531, because of which the soil 500 is loosened. In conjunction with the leading pre-cutter 201, which, in cooperation with the sliding device, enables particularly effective cutting of the biomass, accumulations of biomass or jams or blockages on the trailing soil loosening unit 202 comprising the soil loosening wing 350 are avoided.

The fourth exemplary embodiment of a soil cultivation unit 200 according to the invention according to FIGS. 6a and 6b differs from the third embodiment just described only in the design of the soil loosening unit 202 or the soil loosening wing 350, which is why only this one is described in more detail below. According to the fourth embodiment, the loosening pins and/or loosening elements 300 provided on the side surfaces 351 of the soil cultivation wing 350 are designed with a wedge-like geometry and aligned parallel to one another along the soil cultivation wing 350.

The fifth exemplary embodiment of a soil cultivation unit 200 according to the invention according to FIGS. 7a and 7b also corresponds to the fourth embodiment described above and differs only in terms of a biostimulant, biological product, plant protection agent against insects, pests and diseases, as well as nutrient and/or fertilizer supply 352, which extends along a rear edge of both the upper section 151 and the soil cultivation wing 350 and is used to supply liquid nutrients and/or liquid fertilizers into the seed furrow 530. For this purpose, the working or penetration depth x of the soil cultivation wing 350 expediently exceeds the placement depth of the seed.

Finally, a further exemplary embodiment of a soil cultivation arrangement 100 according to the invention is shown in a schematic perspective illustration in FIG. 8. The soil cultivation arrangement 100 comprises three soil cultivation units 200, which are designed as a pre-cutter 201, a soil loosening unit 202 and a furrow opener 203. The pre-cutter 201 has a single soil cultivation disc 210 and a sliding device 400. With regard to the pulling direction Z, the soil loosening unit 202 is arranged following the pre-cutter 201 and likewise comprises a sliding device 400, which, however, is penetrated by three knives 310 which can be moved up and down transversely to the pulling direction Z. The furrow opener or the sowing disc 203 is arranged with two soil cultivation discs 210 each oriented at an angle to the pulling direction Z, terminating in the pulling direction Z or following the soil loosening unit 202.

During operation, i.e. when an agricultural tractor pulls the soil cultivation arrangement 100 in the pulling direction Z, plant and root residues can first be cut above and below the soil by means of the pre-cutter 201, with an incision in the soil 500 leading to the seed furrow 530 being produced at the same time. By means of the soil loosening unit 202 provided with three knives 310, the soil 500 is then loosened in the area of the seed furrow 530 to be generated. In this embodiment the rectangular cross-sectional area of the soil 500 loosened with the soil loosening unit protrudes the V-shaped cross-sectional area of the seed furrow 530, in particular in the area of the seed furrow walls 531. As a result, the soil is loosened extensively around the seed furrow 530 to be produced, so that compaction of the soil 500 in the region of the seed furrow walls 531 is effectively prevented. Instead of the knives 310, a soil loosening unit 202 having a soil cultivation wing 350 can optionally also be provided at this position. Finally, the furrow opener or the sowing disc 203, the surrounding soil being displaced laterally in the manner of a plow by the inclined soil cultivation discs 210, draws the actual seed furrow 530. In order to prevent the inevitably occurring compression in the area of the seed furrow walls 531 during this work step, the soil cultivation discs 210 are each provided with the loosening pins 300 on their outer circular surface 221. During the generation of the seed furrow 530 they are drawn along a respective cycloid, in particular an epicycloid path through the soil adjacent to the seed furrow walls 531 and loosen them up. A special synergetic effect for loosening the soil can be achieved through the interaction with a loosening unit 202 (see FIGS. 5-7) which precedes the furrow opener 203 and has a loosening wing 350. The loosening pins and/or loosening elements 300 of the soil loosening wing 350 move along respective horizontal paths through the soil. The subsequent loosening pins and/or loosening elements 300 of the furrow opener or the sowing disc 203, which move along epicycloid paths, cross the previously generated horizontal paths multiple times and at different angles, whereby a maximum loosening of the soil in the area of the seed furrow walls 531 is achieved.

Two schematic perspective views of an exemplary embodiment of a soil cultivation unit 200 according to the invention with a soil loosening unit 202 comprising two milling heads 340 arranged next to one another in the pulling direction or forward travel direction Z with axes of rotation 341 aligned parallel to one another can be seen in FIG. 9. Depending on the depth of the seed furrow to be produced, however, more than two milling heads 340 can also be arranged next to one another. For depth control, the soil cultivation unit shown in FIG. 9 is provided with a sliding device 400 which is designed with one or more recesses 430 through which the milling heads 340 pass. Alternatively, the sliding device 400 can also be renounced.

FIG. 10 shows two schematic perspective views of a further exemplary embodiment of a soil cultivation unit 200 according to the invention with a soil loosening unit 202 with a single milling head 340. The milling head 340 or its axis of rotation 341 is arranged here centrally within an optional sliding device 400 and penetrating a recess 430 provided therein. Alternatively, according to FIG. 11, two or more milling heads 340 can also be arranged one behind the other or in a row with respect to the pulling direction or forward travel direction Z. When using several milling heads 340 arranged one behind the other, it has been found to be advantageous to design them with different diameters, the milling head 340 arranged at the front in the forward travel direction Z expediently having the smallest diameter and the milling head 340 arranged at the rear having the largest diameter.

The respective milling heads 340 of the previously described embodiments according to FIGS. 9, 10 and 11 are driven by one or more drive units, not shown here, which are preferably designed as an electrically, pneumatically, mechanically or hydraulically driven rotary actuator. By means of the drive unit and, if necessary, interposed gear elements, the milling heads 340 can be rotated around their respective rotational axis 341 at the desired speed in the same or opposite direction of rotation. The chosen arrangement of the milling heads 340, i.e. a single milling head 340, two or more milling heads 340 next to one another and/or two or more milling heads 340 one behind the other can, if necessary, be adapted to the prevailing soil conditions.

### LIST OF REFERENCE SYMBOLS

100 soil cultivation arrangement
200 soil cultivation unit
201 pre-cutter
202 soil loosening unit
203 furrow opener or seed disc
210 soil cultivation element
211 leading end
212 trailing end
220 circular surface
221 outside circular surface
222 inside circular surface
223 axis of rotation
224 receiving recesses
230 circumferential or running surface
231 cutting edge
232 tooth profile
300 loosening pins
310 knives
320 soil loosening chain
330 teeth
340 milling head
341 axis of rotation
350 soil loosening wings
351 side surface of the soil loosening wing
352 nutrient and/or fertilizer supply
400 sliding device
410 sliding surface
420 front section
430 recess
500 soil
510 soil surface
520 top soil horizon
530 seed furrow
531 seed furrow wall
x working or penetration depth
a seed furrow depth
b seed furrow width
Z direction of pull or forward direction of travel
R direction of rotation
S cutting direction

1. A soil cultivation arrangement (100) for agricultural cultivation of a soil (500) with a carrier device for attaching to an agricultural tractor and with one or more soil cultivation units (200) for soil preparation or to generate a seed furrow (530), which soil cultivation units (200) as modular components of the soil cultivation arrangement (100) can be connected to the carrier device to a sowing unit that can be towed by the agricultural tractor and can be arranged along the carrier device in the desired sequence,
characterized in that
at least one soil cultivation unit (200) has a runner-like sliding device (400) with an underside sliding surface (410) facing the soil (500) and configured to slide on a soil surface (510).

2. A soil cultivation arrangement (100) according to claim 1,
characterized in that
one or more soil cultivation elements (210) protrude from the sliding surface (410) of the sliding device (400) by a variably adjustable working or penetration depth (x).

3. A soil cultivation arrangement (100) according to claim 2,
characterized in that
one or more soil cultivation elements (210) are driven by an actuator independently of travel speed and pulling direction or forward travel direction (Z) of the agricultural tractor.

4. A soil cultivation arrangement (100),
characterized in that
at least one soil cultivation element (210) is configured as a pre-cutter (201) or soil loosening unit (202) and interacts with the sliding device for cutting biomass.

5. A soil cultivation arrangement (100) according to claim 4,
characterized in that
at least one soil cultivation element (210) is configured as a pre-cutter (201) with a single rotatable mounted soil cultivation disc, whereby the soil cultivation disc for cutting biomass and for preparing the seed furrow (530) to be produced along its outer circumferential or running surface (230) is provided with a radially extending cutting or tooth profile (232).

6. A soil cultivation arrangement (100) according to claim 5,
characterized in that
the rotatable mounted soil cultivation disc of the pre-cutter (201) is driven by an actuator independently of the travel speed and against the pulling direction or forward travel direction (Z) of the agricultural tractor.

7. A soil cultivation arrangement (100) according to claim 1,
characterized in that
at least one soil cultivation element (210) is configured as a soil loosening unit (202) with one or more knives (310) which are used for cutting biomass for loosening the soil (500) and for preparing the seed furrow (530) and which knives can be moved translationally to the pulling direction or forward travel direction (Z) of the agricultural tractor.

8. A soil cultivation arrangement (100) according to claim 7,
characterized in that
the one or more knives (310) of the soil loosening unit (202) are arranged to penetrate a slot-like recess (430) of the sliding device (400).

9. A soil cultivation arrangement (100) according to claim 1,
characterized in that
at least one soil cultivation element (210) is configured as a soil loosening unit (202) with a revolving soil loosening chain (320) which is used for cutting plant and root residues, loosening the soil (500) and preparing the seed furrow (530) to be produced in the manner of a motorized chain saw driven by an actuator and configured with a saw tooth profile.

10. A soil cultivation arrangement (100) according to claim 1,
characterized in that
at least one soil cultivation element (210) is configured as a soil loosening unit (202) with a soil loosening wing (350) penetrating the soil (500) starting from the sliding surface (410) of the sliding device (400).

11. A soil cultivation arrangement (100) according to claim 10,
characterized in that
the soil loosening wing (350) is arranged passing or penetrating, the sliding device (400) and can be locked in different positions on the sliding device (400) for the variable setting of a desired working or penetration depth (x).

12. A soil cultivation arrangement (100) according to claim 11,
characterized in that
side surfaces (351) of the soil loosening wing (350) facing a respective seed furrow wall (531) are provided with loosening pins or loosening elements (300), which loosening pins or loosening elements (300) are configured for loosening the soil (500) in the area of the respective seed furrow wall (531).

13. A soil cultivation unit (200) for connection to a carrier device of a soil cultivation arrangement (100) according to claim 1, with one or more soil cultivation elements (210) for loosening the soil or for cutting biomass,
characterized in that
the soil cultivation unit (200) has a runner-like sliding device (400) with a sliding surface (410) facing the soil on its underside which is configured to slide on a soil surface (510).

14. A soil cultivation unit (200) according to claim 13,
characterized in that
the soil cultivation unit (200) has at least one soil cultivation element (210) configured as a pre-cutter (201) and one soil cultivation element (210) configured as a soil loosening unit (202).

15. A soil cultivation unit (200) according to claim 14,
characterized in that
the soil cultivation element (210) configured as a pre-cutter (201) and the soil cultivation element (210) configured as a soil loosening unit (202) each protrude from the sliding surface (410) of the sliding device (400) by a variably adjustable working or penetration depth (x).
